(19) United States
(12) Patent Application Publication
(10) Pub. No.: US 2019/0064957 A1
(43) Pub. Date: Feb. 28, 2019

(54) TOUCH SCREEN AND FABRICATING METHOD THEREOF, AND OUT-CELL TOUCH DISPLAY DEVICE

(71) Applicants: BOE Technology Group Co., Ltd., Beijing (CN); Hefei Xinsheng Optoelectronics Technology Co., Ltd, Hefei, Anhui (CN)

(72) Inventors: Jing WANG, Beijing (CN); Xiadong XIE, Beijing (CN); Shuncheng ZHU, Beijing (CN); Min HE, Beijing (CN); Guiyu ZHANG, Beijing (CN); Qiato ZHENG, Beijing (CN); Zouming XU, Beijing (CN); Dong LI, Beijing (CN)

(21) Appl. No.: 15/750,320

(22) PCT Filed: Jul. 25, 2017
(86) PCT No.: PCT/CN2017/094262

§ 371 Date: Feb. 5, 2018

(30) Foreign Application Priority Data
Aug. 4, 2016 (CN) 201610631632.7

(51) Int. Cl. G06F 3/044; G06F 3/041

(52) U.S. Cl. CPC G06F 3/044; G06F 2203/04103; G06F 3/0412

(57) ABSTRACT

A touch screen and the fabricating method thereof and an out-cell touch display device solve the problem of shadow elimination of bridge points. The method for fabricating the touch screen includes: forming a pattern of a first touch detection electrode on a substrate; forming a pattern of a first metal wiring layer which is at least electrically connected with the first touch detection electrode, in the frame area of the substrate; forming a pattern of the first insulating layer on the side, far away from the substrate, of the first metal wiring layer; forming a pattern of a second touch detection electrode on the side, far away from the substrate, of the first insulating layer; and forming a pattern of a second metal wiring layer which is at least electrically connected with the second touch detection electrode, in the frame area of the substrate.

This application is a US National Stage of International Application No. PCT/CN2017/094262, filed on Jul. 25, 2017, designating the United States and claiming the priority to Chinese Patent Application No. 201610631632.7, filed on Aug. 4, 2016, the content of which is hereby incorporated by reference in its entirety.

### FIELD

The embodiments of the present disclosure relate to a touch screen and a fabricating method thereof, and an out-cell touch display device.

### BACKGROUND

The popularity of the touch technology is getting higher and higher since its emergence. In terms of different induction manners, the touch technology is roughly categorized into a resistive touch technology, a capacitive touch technology, an infrared touch technology and a sonic touch technology. Among the four types, the resistive and capacitive touch technologies are in greatest need on the market, and it is difficult for the other technologies to catch up with the two within a short period. Along with the recognition of the touch experience, the capacitive touch technology is gradually replacing the resistive touch technology. The capacitive touch technology can be classified into a mutual-capacitive touch technology and a self-capacitive touch technology. As the mutual-capacitive touch technology can realize multi-touch, it has become a mainstream in the market and indicates the tendency of future development.

Generally, the mutual-capacitive touch display device can be classified into an out-cell touch display device and an embedded touch display device. The out-cell touch display device can be mainly divided into types such as G+G, GFF, one glass solution (OGS) and On cell, among which the touch display device with an On cell structure means that the touch screen is embedded between a color filter substrate and a polarizer of a display device, that is, the touch screen is arranged on a liquid crystal display panel.

### SUMMARY

At least one embodiment of the present disclosure provides a method for fabricating a touch screen, and the method includes: forming a pattern of a first touch detection electrode on a substrate; forming a pattern of a first metal wiring layer which is at least electrically connected with the first touch detection electrode, in a frame area of the substrate; forming a first insulating layer on a side, far away from the substrate, of the first metal wiring layer; forming a pattern of a second touch detection electrode on a side, far away from the substrate, of the first insulating layer; and forming a pattern of a second metal wiring layer which is at least electrically connected with the second touch detection electrode, in the frame area of the substrate.

For example, in the fabricating method according to one embodiment of the present disclosure, the method further includes: providing a same mask to form the pattern of the first metal wiring layer and the pattern of the second metal wiring layer.

For example, in the fabricating method according to one embodiment of the present disclosure, the providing the same mask to form the pattern of the first metal wiring layer and the pattern of the second metal wiring layer includes: providing the same mask to form a first metal wire connected with the first touch detection electrode, and to form a second metal wire connected with the second touch detection electrode.

For example, in the fabricating method according to one embodiment of the present disclosure, after forming the pattern of the second metal wiring layer, the method further includes: forming a second insulating layer on a side, far away from the substrate, of the second metal wiring layer by an evaporation process.

For example, in the fabricating method according to one embodiment of the present disclosure, before forming a pattern of the first touch detection electrode on the substrate, the method further includes: forming a pattern of a black matrix in the frame area of the substrate.

For example, in the fabricating method according to one embodiment of the present disclosure, the first metal wiring layer includes the first metal wire and a first connecting wire arranged in the same layer as the first metal wire, and the first connecting wire and the second metal wire are of the same shape.

For example, in the fabricating method according to one embodiment of the present disclosure, the second metal wiring layer includes the second metal wire and a second connecting wire arranged in the same layer as the second metal wire, and the second connecting wire and the first metal wire are of the same shape.

For example, in the fabricating method according to one embodiment of the present disclosure, the first touch detection electrode is a touch driving electrode and the second touch detection electrode is a touch sensing electrode; or, the first touch detection electrode is a touch sensing electrode and the second touch detection electrode is a touch driving electrode.

At least one embodiment of the present disclosure provides a touch screen which includes: a substrate; a first touch detection electrode arranged on the substrate; a first metal wiring layer arranged on a side, far away from the substrate, of the film layer in which the first touch detection electrode is located, wherein the first metal wiring layer is located in the frame area of the substrate, and the first metal wiring layer is at least electrically connected with the first touch detection electrode; a first insulating layer arranged on a side, far away from the substrate, of the first metal wiring layer; a second touch detection electrode arranged on a side, far away from the substrate, of the first insulating layer; and a second metal wiring layer arranged on a side, far away from the substrate, of the film layer in which the second touch detection electrode is located, wherein the second metal wiring layer is located in the frame area of the substrate, and the second metal wiring layer is at least electrically connected with the second touch detection electrode.

For example, in the touch screen according to one embodiment of the present disclosure, a pattern of the first metal wiring layer and a pattern of the second metal wiring layer are the same.

For example, in the touch screen according to one embodiment of the present disclosure, the first metal wiring layer includes a first metal wire connected with the first touch detection electrode, and the second metal wiring layer includes a second metal wire connected with the second touch detection electrode.

For example, in the touch screen according to one embodiment of the present disclosure, the first metal wiring layer includes the first metal wire and a first connecting wire arranged in the same layer as the first metal wire, and the first connecting wire and the second metal wire are of the same shape.

For example, in the touch screen according to one embodiment of the present disclosure, the second metal wiring layer includes the second metal wire and a second connecting wire arranged in the same layer as the second metal wire, and the second connecting wire and the first metal wire are of the same shape.

For example, in the touch screen according to one embodiment of the present disclosure, the first touch detection electrode is a touch driving electrode and the second touch detection electrode is a touch sensing electrode; or, the first touch detection electrode is a touch sensing electrode and the second touch detection electrode is a touch driving electrode.

For example, the touch screen according to one embodiment of the present disclosure further includes: a black matrix arranged between the substrate and the first touch detection electrode, wherein the black matrix is located in the frame area.

For example, the touch screen according to one embodiment of the present disclosure further includes: a second insulating layer arranged on a side, far away from the substrate, of the second metal wiring layer.

At least one embodiment of the present disclosure further provides an out-cell touch display device which includes: an array substrate; an opposite substrate arranged opposite to the array substrate; and a touch screen arranged on a side, far away from the array substrate, of the opposite substrate, wherein the touch screen includes the touch screen of any of the above items.

In the touch screen and the fabricating method thereof and the out-cell touch display device according to the embodiments of the present disclosure, through the forming of the first touch detection electrode and the second touch detection electrode which are of a different-layer structure on the substrate, and through the forming of a first metal wiring layer connected with the first touch detection electrode and a second metal wiring layer connected with the second touch detection electrode in the frame area of the substrate, the metal wiring layers are only located in the frame area of the substrate, and the first touch detection electrode and the second touch detection electrode in the touch area are insulated from each other via the first insulating layer, and no bridge connection needs to be designed to realize the connection of the first touch detection electrode or the second touch detection electrode, thereby avoiding from solving the problem of shadow elimination of the bridge points.

### BRIEF DESCRIPTION OF THE DRAWINGS

FIG. 1 is a flow diagram of the method for fabricating a touch screen according to an embodiment of the present disclosure;

FIG. 2A to FIG. 2H are structural schematic diagrams after each step of the method for fabricating the touch screen according to the embodiment of the present disclosure is executed;

FIG. 3 is a structural schematic diagram of a touch screen according to an embodiment of the present disclosure;

FIG. 4 is a structural schematic diagram of a metal wiring layer according to an embodiment of the present disclosure;

FIG. 5 is a structural schematic diagram of a second touch screen according to an embodiment of the present disclosure;

FIG. 6 is a structural schematic diagram of a third touch screen according to an embodiment of the present disclosure;

FIG. 7 is a structural schematic diagram of an out-cell touch display device according to an embodiment of the present disclosure;

FIG. 8 is a structural schematic diagram of a second out-cell touch display device according to an embodiment of the present disclosure;

FIG. 9 is a structural schematic diagram of a third out-cell touch display device according to an embodiment of the present disclosure.

### DETAILED DESCRIPTION OF THE EMBODIMENTS

In order to make the objectives, technical solutions, and advantages of the embodiments of the present disclosure more apparent, a clear and complete description will be given below on the technical solutions of the embodiments in the present disclosure in combination with the accompanying drawings of the embodiments of the present disclosure, and apparently the embodiments described below are only a part but not all of the embodiments of the present disclosure. Based upon the described embodiments of the present disclosure, all the other embodiments which can occur to those skilled in the art without any inventive effort shall all fall into the protection scope of the present disclosure.

Unless otherwise defined, the technical terms or scientific terms used in the present disclosure should denote the ordinary meaning understood by those skilled in the art to which the present disclosure pertains. The “first”, “second” and similar words used in the present disclosure do not denote any sequence, quantity or importance, but are only used for differentiating different components. “Comprise” or “include” and such similar words mean that the elements or objects occurring before such words cover the enumerated elements or objects and their equivalents occurring after such words, but do not exclude other elements or objects. “Connect” or “connected” and such similar words are not limited to physical or mechanical connection, but can include electrical connection, no matter in a direct or indirect way.

In ordinary touch display device field, both On cell and OGS are confronted with problems such as high development cost, high complexity of the technological process, large quantities of the Masks, and poor visibility of the bridge points. In order to effectively lower the cost of the touch module and simultaneously satisfy the performance of multi-touch, in the recent two years, the practitioners in the touch industry have been actively engaged in the research of a technology in which the number of photomasks can be reduced and the complexity of the technological process can be lowered, and arranged to develop the OGS, On cell or GF thin film technology.

At present, some touch manufacturers have begun to produce the single layer on cell (SLOC) products. Owing to its simple fabricating process and low fabricating cost, the SLOC products have attracted much attention. However, in the large-scale production and use process of the SLOC products, since the touch area and the wiring area of the products are both fabricated by using the indium tin oxides (ITO) materials, and as the sheet resistivity of the ITO is higher and the channel impedance is overlarge, the SLOC products cannot realize large-size multi-touch. In addition, some touch manufacturers further take transparent optical cement materials as an insulating layer and design via holes in the transparent optical cement materials, so as to reduce the number of the photomasks, and use the ITO bridge to replace the metal bridge to solve the problem of shadow elimination, and change the commonly-used 6 masks to 5 masks. However, these designs cannot fundamentally reduce the research and development costs and lower the production cost dramatically, and cannot improve the comprehensive competitiveness of the products and solve the problem of visibility of the bridge points.

The present disclosure provides a touch screen and a fabricating method thereof and an out-cell touch display device. In the fabricating method of the touch screen, through the forming of the first touch detection electrode and the second touch detection electrode which are of a different-layer structure on the substrate, and through the forming of a first metal wiring layer connected with the first touch detection electrode and a second metal wiring layer connected with the second touch detection electrode in the frame area of the substrate, the metal wiring layers are only located in the frame area of the substrate, and the first touch detection electrode and the second touch detection electrode in the touch area are insulated from each other via the first insulating layer, and no bridge connection needs to be designed to realize the connection of the first touch detection electrode or the second touch detection electrode, thereby avoiding from solving the problem of shadow elimination of the bridge points. In addition, for the touch screen according to the embodiment of the present disclosure, no ITO material is needed in the fabricating of the metal wiring area in the frame area, and no transparent optical cement (OC) insulating layer needs to be designed in the touch area, thereby lowering the design cost. Therefore, under the premise of lowering the cost, the touch screen according to the embodiment of the present disclosure solves the problem of shadow elimination of the bridge points and then improves the competitiveness of products.

A detailed description will be given below on the implementations of the touch screen and the fabricating method thereof and the out-cell touch display device according to the embodiments of the present disclosure in combination with the accompanying drawings.

In the drawings, the thickness and shape of each film layer do not reflect the actual proportion, only aiming at schematically illustrating the content of the present disclosure.

FIG. 1 shows a method for fabricating a touch screen according to at least one embodiment, the method includes the following steps S101 to S105.

S101 is to form a pattern of a first touch detection electrode on a substrate.

S102 is to form a pattern of a first metal wiring layer which is at least electrically connected with the first touch detection electrode, in the frame area of the substrate.

S103 is to form a first insulating layer on the side, far away from the substrate, of the first metal wiring layer. It should be noted that, the first insulating layer is formed in the touch area and the frame area of the substrate at the same time.

S104 is to form a pattern of a second touch detection electrode on the upper side of the first insulating layer. It should be noted that, the upper side of the first insulating layer refers to the side far away from the substrate.

S105 is to form a pattern of a second metal wiring layer which is at least electrically connected with the second touch detection electrode, in the frame area of the substrate.

It should be noted that, the first touch detection electrode can be used as a touch driving electrode, and the second touch detection electrode can be used as a touch sensing electrode; or, the first touch detection electrode can be used as a touch sensing electrode, and the second touch detection electrode can be used as a touch driving electrode, and these are not limited herein in the embodiment of the present disclosure.

The method for fabricating the touch screen according to the embodiment of the present disclosure includes: forming a pattern of a first touch detection electrode on a substrate; forming a pattern of a first metal wiring layer which is at least electrically connected with the first touch detection electrode, in the frame area of the substrate; forming a pattern of the first insulating layer on the upper side of the substrate with the first metal wiring layer; forming a pattern of the second touch detection electrode on the upper side of the first insulating layer; and forming a pattern of the second metal wiring layer which is at least electrically connected with the second touch detection electrode, in the frame area of the substrate. Therefore, in the above method for fabricating the touch screen according to the embodiment of the present disclosure, through the forming of the first touch detection electrode and the second touch detection electrode which are of a different-layer structure on the substrate, and through the forming of a first metal wiring layer connected with the first touch detection electrode and a second metal wiring layer connected with the second touch detection electrode in the frame area of the substrate, the metal wiring layers are only located in the frame area, and the first touch detection electrode and the second touch detection electrode in the touch area are insulated from each other via the first insulating layer, and no bridge connection needs to be designed to realize the connection of the first touch detection electrode or the second touch detection electrode, thereby avoiding from solving the problem of shadow elimination of the bridge points. In addition, for the touch screen according to the embodiment of the present disclosure, no ITO material is needed in the fabricating of the metal wiring area in the frame area, and no OC insulating layer needs to be designed in the touch area, thereby lowering the design cost. Therefore, under the premise of lowering the cost, the touch screen according to the embodiment of the present disclosure solves the problem of shadow elimination of the bridge points and then improves the competitiveness of products.

For example, the pattern of the first touch detection electrode can include a plurality of first touch detection electrodes which extend along the first direction and are arranged in an insulating manner along the second direction; and each of the first touch detection electrodes includes a plurality of rhombic electrode blocks which are distributed along the first direction or electrode blocks of any other shapes.

For example, the pattern of the second touch detection electrode can include a plurality of second touch detection electrodes which extend along the second direction and arranged in an insulating manner along the first direction; and each of the second touch detection electrodes includes a plurality of rhombic electrode blocks which are distributed along the second direction or electrode blocks of any other shapes.

For example, the touch screen includes a touch area and a frame area, that is, the substrate also includes a touch area and a frame area. For the touch screen according to the embodiment of the present disclosure, the touch area does not include a metal wiring layer, and the metal wiring layer is only formed in the frame area, thereby avoiding the problem of metal shadow elimination.

For example, in the above method for fabricating the touch screen according to the embodiment of the present disclosure, in order to further reduce the fabricating cost of the touch screen and reduce the times of photomasks, in the embodiments of the present disclosure, the same mask is provided to form the pattern of the first metal wiring layer and the pattern of the second metal wiring layer. Therefore, in the method for fabricating the touch screen according to the embodiment of the present disclosure, the fabricating in different steps and simultaneous conduction of the first metal wiring layer and the second metal wiring layer can be realized, thereby realizing good touch effect with large-size multi-touch.

For example, the same mask is provided to form the first metal wiring layer and the second metal wiring layer, so that only one mask is required to form the first metal wiring layer and the second metal wiring layer. In the method for fabricating the touch screen according to the embodiment of the present disclosure, 3 masks can be provided in the fabricating process, where the first mask is used for forming a pattern of the first touch detection electrode on the substrate, the second mask is used for forming a pattern of the first metal wiring layer and a pattern of the second metal wiring layer in the frame area, and the third mask is used for forming a second touch detection electrode on the upper side of the first insulating layer. Therefore, in the method for fabricating the touch screen according to the embodiment of the present disclosure, through providing the same mask to form the first metal wiring layer and the second metal wiring layer, when the touch screen is formed, four processes and three masks can be provided.

For example, in the above method for fabricating the touch screen according to the embodiment of the present disclosure, the providing the same mask to form a pattern of the first metal wiring layer and a pattern of the second metal wiring layer includes: providing the same mask to form a pattern of the first metal wire connected with the first touch detection electrode, and to form a pattern of the second metal wire connected with the second touch detection electrode.

For example, when the same mask is provided to form the first metal wiring layer and the second metal wiring layer, and when the first metal wiring layer connected with the first touch detection electrode is formed, the mask includes a pattern used for forming the second metal wiring layer, thereby forming the second metal wiring layer connected with the second touch detection electrode at the same time. For example, the first metal wiring layer includes a first metal wire connected with the first touch detection electrode and a first connecting wire arranged in the same layer as the first metal wire, and the pattern of the first connecting wire is the same as that of the second metal wire. For example, a via hole can be arranged in the first insulating layer so that the first connecting wire is electrically connected with the second touch detection electrode, or no via hole is arranged so that the first connecting wire is insulated from the second touch detection electrode. Similarly, the second metal wiring layer includes a second metal wire connected with the second touch detection electrode and a second connecting wire arranged in the same layer as the second metal wire, and the pattern of the second connecting wire is the same as that of the first metal wire. For example, a via hole can be arranged in the first insulating layer so that the second connecting wire is electrically connected with the first touch detection electrode, or no via hole is arranged so that the second connecting wire is insulated from the first touch detection electrode.

For example, in the above method for fabricating the touch screen according to the embodiment of the present disclosure, after forming the pattern of the second metal wiring layer, the method further includes: forming a second insulating layer on the upper side of the substrate with the second metal wiring layer by an evaporation process, where the second insulating layer can be used as a protective layer of the touch screen, thereby improving the shadow elimination effect of the pattern of the touch screen.

For example, in the above method for fabricating the touch screen according to the embodiment of the present disclosure, the material of the insulating layer is silicon oxynitride or silicon dioxide. The insulating layer in the embodiment of the present disclosure includes a first insulating layer and a second insulating layer. Therefore, the materials of the first insulating layer and the second insulating layer can be both any one of silicon oxynitride or silicon dioxide, or can be the combination of the two; or, the material of the first insulating layer or the second insulating layer can be any one of silicon oxynitride or silicon dioxide, or can be the combination of the two, and these are not limited herein. The second insulating layer fabricated from silicon oxynitride or silicon dioxide can be used as a protective layer of the touch screen, thereby further avoiding the shadow elimination of the bridge points and improving the shadow elimination effect of the pattern of the touch screen.

For example, in the above method for fabricating the touch screen according to the embodiment of the present disclosure, before forming a pattern of the first touch detection electrode on the substrate, the method further includes: forming a pattern of a black matrix in the frame area of the substrate. The pattern of the black matrix is formed to shield the first metal wiring layer and the second metal wiring layer in the frame area.

In addition, since the black matrix in the embodiment of the present disclosure is located below the first touch detection electrode in the frame area, the lapped part between the black matrix and the first touch detection electrode forms a closed loop. Thus the static electricity on the first touch detection electrode above the black matrix is released to the GND wire via the closed loop of the black matrix, and the static electricity is released through the connection between the GND pin and the GND wire on the printed circuit board, thereby further avoiding the black matrix in the touch screen from being broken down by the static electricity, and preventing the touch area from forming a conductive channel or from short circuit.

An embodiment of the present disclosure provides a fabricating method of a touch screen, and the method includes the following steps.

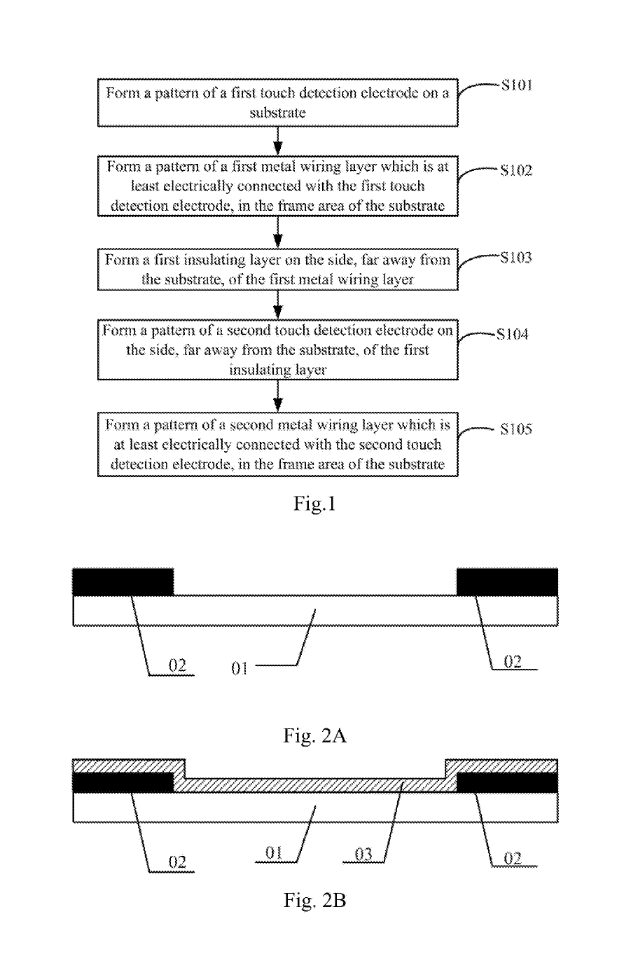

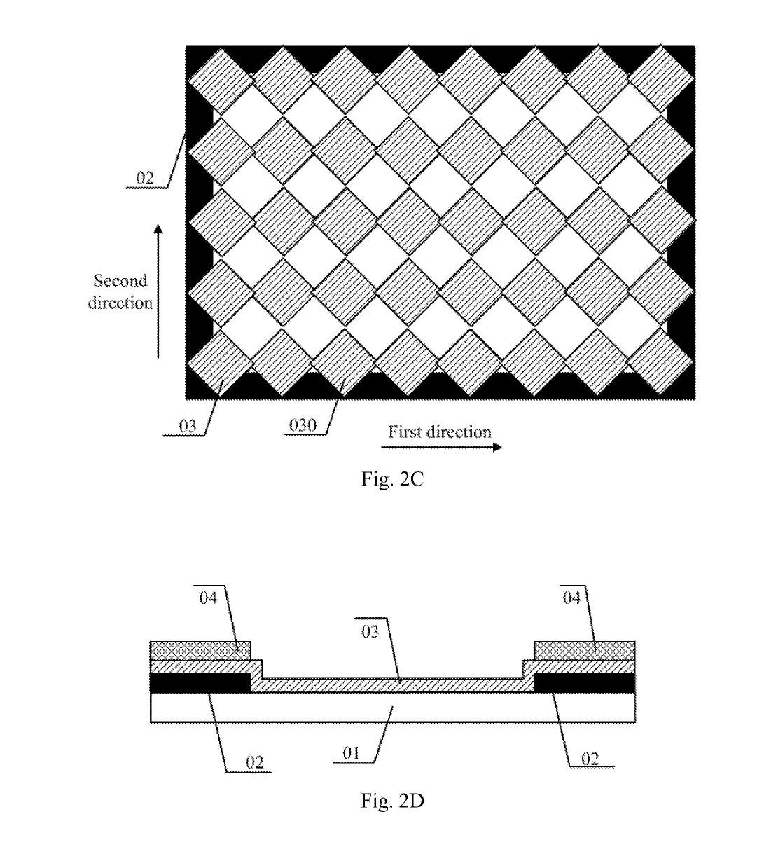

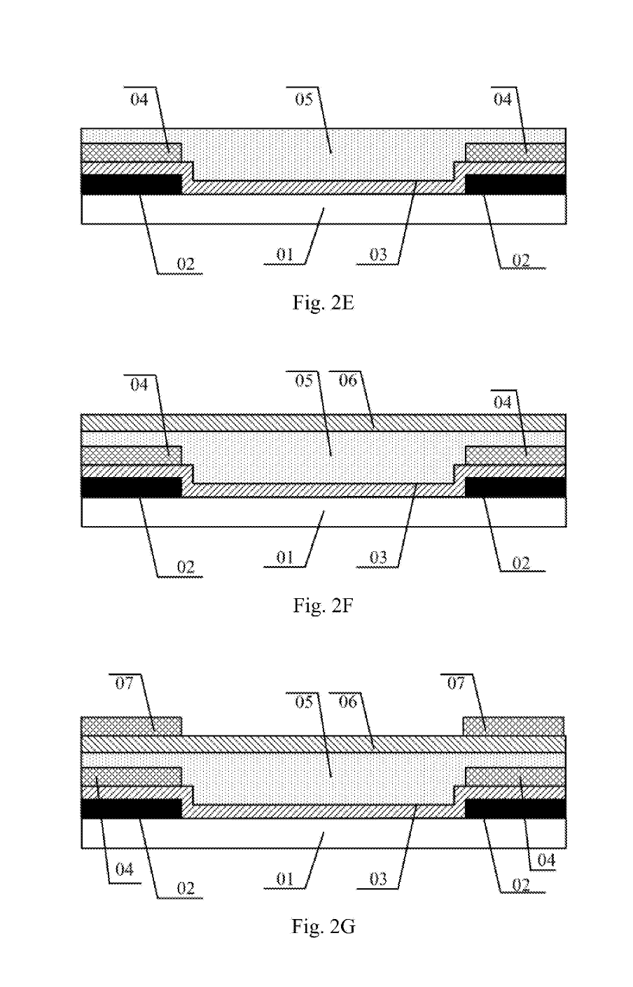

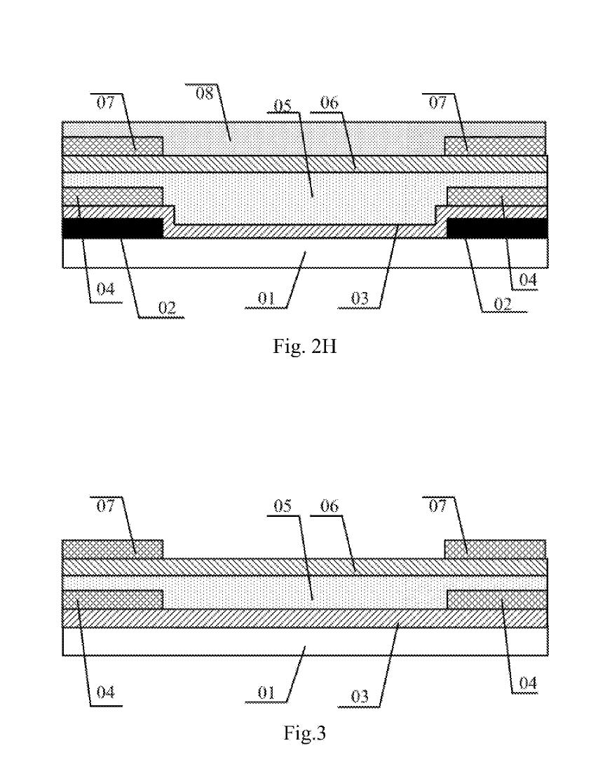

Step 1: forming a pattern of a black matrix 02 in the frame area of the substrate 01, as shown in FIG. 2A. For example, a pattern of the black matrix can be formed on the substrate through patterning processes including coating, exposing and developing. It should be noted that the step of forming the pattern of the black matrix is an optional step, and step 2 can be directly executed.

Step 2: as shown in FIG. 2B which is a sectional view of FIG. 2C, forming a pattern of the first touch detection electrode 03 in the frame area and the touch area in the substrate 01. In order to further illustrate the structure of the first touch detection electrode, please refer to FIG. 2C, the pattern of the first touch detection electrode 03 can include a plurality of first touch detection electrodes 03 which extend along the first direction and are arranged in an insulating manner along the second direction; and each first touch detection electrode 03 includes a plurality of rhombic electrode blocks 030 which are distributed along the first direction or electrode blocks of any other shapes. For example, the pattern of the first touch detection electrode can be formed by coating a layer of an ITO film layer, coating photoresist, exposing and developing the photoresist, and finally etching the ITO film layer on the substrate. It should be noted that, the pattern of the first touch detection electrode not only includes the structure shown in FIG. 2C, but also can be the structure of other shapes, and the structures are not limited herein in the embodiment of the present disclosure.

Step 3: providing a mask to form a pattern of the first metal wiring layer 04 electrically connected with the first touch detection electrode, in the frame area of the substrate 01, as shown in FIG. 2D. For example, the pattern of the first metal wiring layer can be formed through metal coating, coating photoresist, exposing and developing the photoresist and then etching the metal coating in the frame area of the substrate.

Step 4: forming the pattern of the first insulating layer 05 on the upper side of the first metal wiring layer, as shown in FIG. 2E. For example, an evaporation mode can be provided to form the pattern of the first insulating layer, and the pattern of the first insulating layer is of a whole-layer structure.

Step 5: forming a pattern of the second touch detection electrode 06 on the upper side of the first insulating layer 05, as shown in FIG. 2F. The first insulating layer is located between the first metal wiring layer and the second touch detection electrode, and is located between the first touch detection electrode and the second touch detection electrode. The shape of the second touch detection electrode is the same as that of the first touch detection electrode in FIG. 2C, and the projection of each second touch detection electrode on the substrate is not overlapped with the projection of the first touch detection electrode on the substrate.

Step 6: providing the same mask to form a pattern of the second metal wiring layer 07 on the upper side of the second touch detection electrode 06, as shown in FIG. 2G. The masks provided for forming the second metal wiring layer and the first metal wiring layer are the same, and the pattern of the second metal wiring layer is formed through metal coating, coating photoresist, exposing and developing the photoresist, and then etching the metal coating on the upper side of the second touch detection electrode in the frame area of the substrate.

Step 7: forming a second insulating layer 08 on the upper side of the second metal wiring layer 07, as shown in FIG. 2H. The second insulating layer is located in the frame area and the touch area, and the pattern of the second insulating layer can be formed in an evaporation mode. For example, the material of the first insulating layer and the second insulating layer can be SiNxOy or SiO₂.

For example, the material of the first touch detection electrode and the second touch detection electrode is indium tin oxide.

For example, a touch screen is formed through the above steps 1 to 7, and a patterning process is required in steps 1 to 7 for patterning. The patterning process can only include a photolithographic process, or can include a photolithographic process and an etching step, and at the same time can also include other processes such as printing and ink jet used for forming a predetermined pattern. The etching process is a process which includes technological processes such as film formation, exposing and developing and which utilizes the photoresist, a mask and an exposure machine to form patterns. For example, corresponding patterning processes can be selected based on the structure to be formed in the present disclosure.

Based on the same inventive concept, the embodiment of the present disclosure further provides a touch screen. Please refer to FIG. 3, the touch screen includes: a substrate 01; a first touch detection electrode 03 arranged on the substrate; a first metal wiring layer 04 arranged on the film layer (on the side far away from the substrate 01) in which the first touch detection electrode 03 is located, the first metal wiring layer is located in the frame area 011 of the substrate 01, and the first metal wiring layer is at least electrically connected with the first touch detection electrode; a first insulating layer 05 arranged on the first metal wiring layer 04; a second touch detection electrode 06 arranged on the first insulating layer 05; and a second metal wiring layer 07 arranged on the film layer (on the side far away from the substrate 01) in which the first touch detection electrode is located, the second metal wiring layer is located in the frame area 011, and the second metal wiring layer is at least electrically connected with the second touch detection electrode 06.

For example, in the touch screen according to the embodiment of the present disclosure, the pattern of the first metal wiring layer is the same as that of the second metal wiring layer. Since the pattern of the first metal wiring layer is the same as that of the second metal wiring layer, when the first metal wiring layer and the second metal wiring layer are fabricated, the same mask can be provided, thereby saving the times of the masks for fabricating the touch screen, and saving cost.

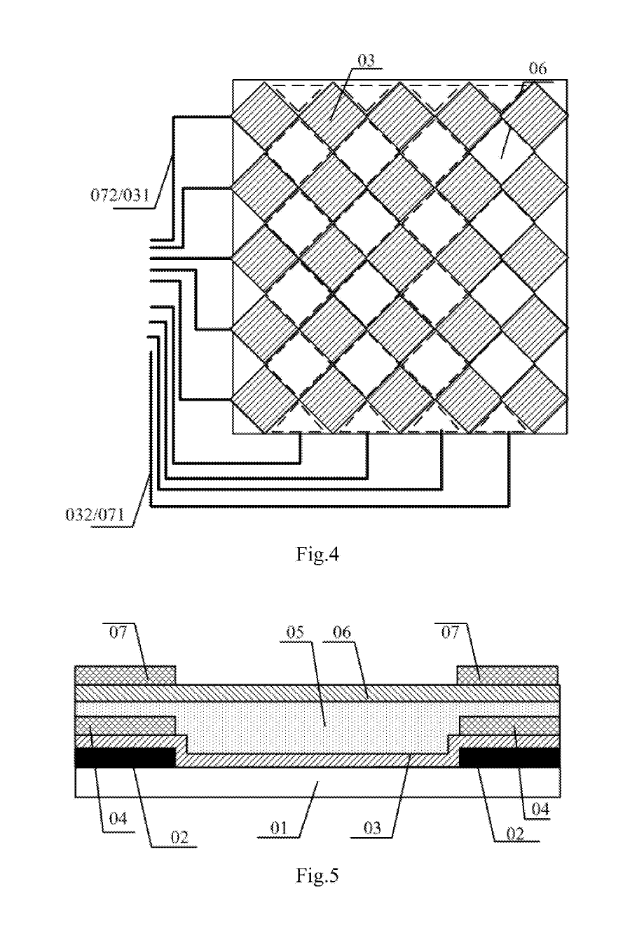

For example, in the above touch screen according to the embodiment of the present disclosure, please refer to FIG. 4, the first metal wiring layer includes: a first metal wire 031 connected with the first touch detection electrode 03. The second metal wiring layer includes a second metal wire 071 connected with the second touch detection electrode 06 (the dotted box in FIG. 4 only represents the area used for forming the second touch detection electrode). The first metal wire is used for connecting the printed circuit board and the first touch detection electrode, and the second metal wire is used for connecting the printed circuit board and the second touch detection electrode.

For example, in the above touch screen according to the embodiment of the present disclosure, please refer to FIG. 4, the first metal wiring layer includes a first metal wire 031 and a first connecting wire 032 (with the same shape as the second metal wire 071) arranged in the same layer as the first metal wire 031. Since the first connecting wire is of the same shape as the second metal wire, the first connecting wire is located on the side, close to the substrate, of the second metal wire.

For example, in the above touch screen according to the embodiment of the present disclosure, please refer to FIG. 4, the second metal wiring layer includes a second metal wire 071 and a second connecting wire 072 (with the same shape as the first metal wire 031) arranged in the same layer as the second metal wire 071. Since the second connecting wire is of the same shape as the first metal wire, the first metal wire is located on the side, close to the substrate, of the second connecting wire.

For example, the first touch detection electrode is a touch driving electrode, and the second touch detection electrode is a touch sensing electrode; or, the first touch detection electrode is a touch sensing electrode and the second touch detection electrode is a touch driving electrode.

For example, in the above touch screen according to the embodiment of the present disclosure, please refer to FIG. 5, the touch screen further includes: a black matrix 02 arranged in the frame area between the substrate 01 and the first touch detection electrode 03. The black matrix is used for shielding the first metal wiring layer and the second metal wiring layer in the frame area. Since the black matrix in the embodiment of the present disclosure is located below the first touch detection electrode in the frame area, the lapped part between the black matrix and the first touch detection electrode forms a closed loop. Thus the static electricity on the first touch detection electrode above the black matrix is released to the GND wire via the closed loop of the black matrix, and the static electricity is released through the connection between the GND pin and the GND wire on the printed circuit board, thereby further avoiding the black matrix in the touch screen from being broken down by the static electricity, and preventing the touch area from forming a conductive channel or from short circuit.

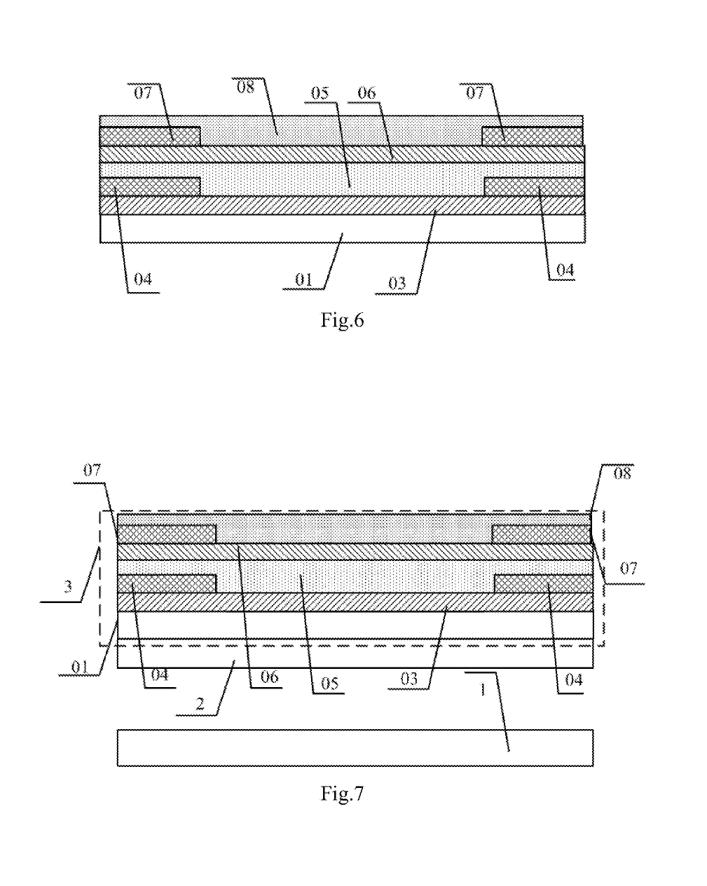

For example, in the above touch screen according to the embodiment of the present disclosure, please refer to FIG. 6, the touch screen further includes: a second insulating layer 08 arranged on the second metal wiring layer 07.

For example, in the touch screen according to the embodiment of the present disclosure, the material of the first insulating layer and the second insulating layer is silicon oxynitride or silicon dioxide. The second insulating layer fabricated from silicon oxynitride or silicon dioxide can be used as a protective layer of the touch screen, thereby further avoiding the shadow elimination of the bridge points and improving the shadow elimination effect of the pattern of the touch screen.

Based on the same inventive concept, the embodiment of the present disclosure further provides an out-cell touch display device. Please refer to FIG. 7, the out-cell touch display device includes an array substrate 1 and an opposite substrate 2 which are arranged oppositely, and a touch screen 3 according to the embodiment of the present disclosure and arranged on the side, far away from the array substrate 1, of the opposite substrate 2.

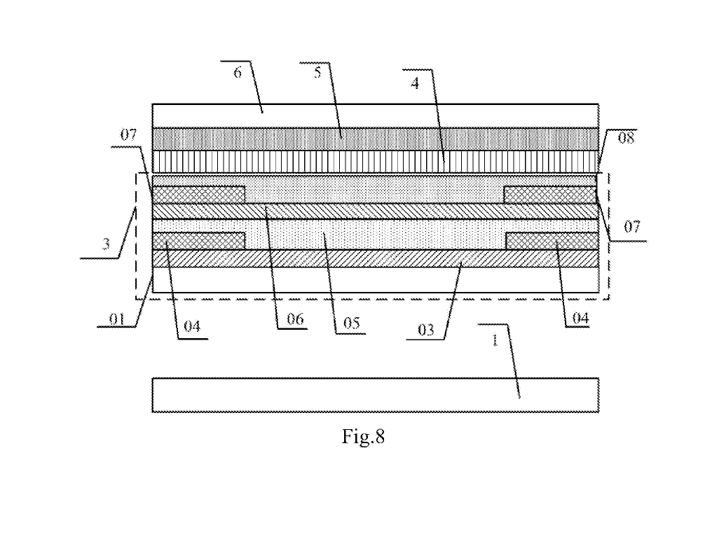

For example, in the above out-cell touch display device according to the embodiment of the present disclosure, for the out-cell touch display device with an on cell structure, please refer to FIG. 8, the substrate 01 of the touch screen 3 is an opposite substrate 2. Preferably, the out-cell touch display device further includes a polarizer 4 located above the touch screen 3, an optical clear resin (OCR) 5 located above the polarizer, and a cover plate 6 arranged above the OCR.

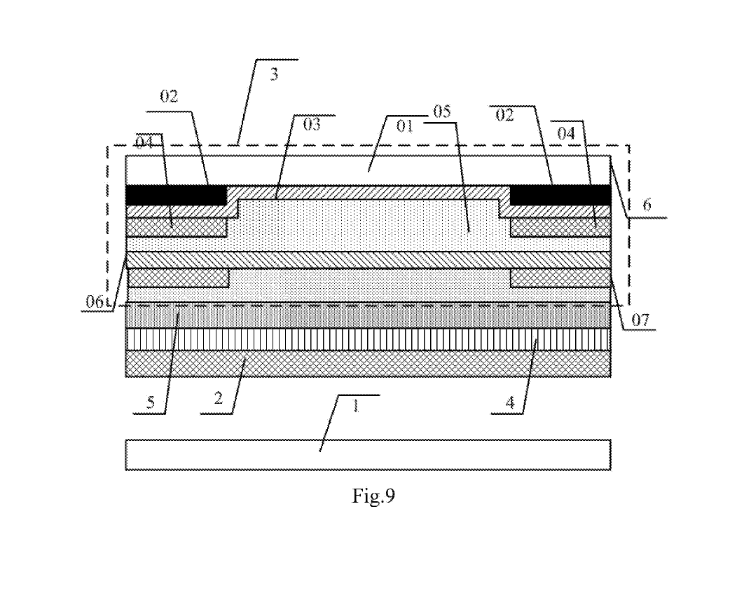

For example, in the above out-cell touch display device according to the embodiment of the present disclosure, for the out-cell touch display device with an OGS structure, please refer to FIG. 9, the substrate 01 of the touch screen 3 is a cover plate of the out-cell touch display device. Preferably, the out-cell touch display device further includes: a polarizer 4 located between the touch screen and the opposite substrate, and an OCR 5 located between the polarizer 4 and the touch screen 3.

The embodiments of the present disclosure provide a touch screen and a fabricating method thereof, and an out-cell touch display device. The method for fabricating the touch screen includes: forming a pattern of a first touch detection electrode on a substrate; forming a pattern of a first metal wiring layer which is at least electrically connected with the first touch detection electrode, in the frame area of the substrate; forming a pattern of the first insulating layer on the upper side of the substrate with the first metal wiring layer; forming a pattern of the second touch detection electrode on the upper side of the first insulating layer; and forming a pattern of the second metal wiring layer which is at least electrically connected with the second touch detection electrode, in the frame area of the substrate. Therefore, in the above method for fabricating the touch screen according to the embodiment of the present disclosure, through the forming of the first touch detection electrode and the second touch detection electrode which are of a different-layer structure on the substrate, and through the forming of a first metal wiring layer connected with the first touch detection electrode and a second metal wiring layer connected with the second touch detection electrode in the frame area of the substrate, the metal wiring layers are only located in the frame area, and the first touch detection electrode and the second touch detection electrode in the touch area are insulated from each other via the first insulating layer, and no bridge connection needs to be designed to realize the connection of the first touch detection electrode or the second touch detection electrode, thereby avoiding from solving the problem of shadow elimination of the bridge points. In addition, for the touch screen according to the embodiment of the present disclosure, no ITO material is needed in the fabricating of the metal wiring area in the frame area, and no OC insulating layer needs to be designed in the touch area, thereby lowering the design cost. Therefore, under the premise of lowering the cost, the touch screen according to the embodiment of the present disclosure solves the problem of shadow elimination of the bridge points and then improves the competitiveness of products.

Evidently, those skilled in the art can make various modifications and variations to the present disclosure without departing from the spirit and scope of the present disclosure. Accordingly the present disclosure is also intended to encompass these modifications and variations thereto so long as the modifications and variations come into the scope of the claims appended to the present disclosure and their equivalents.

1. A method for fabricating a touch screen, the method comprising:
forming a pattern of a first touch detection electrode on a substrate;
forming a pattern of a first metal wiring layer which is at least electrically connected with the first touch detection electrode, in a frame area of the substrate;
forming a first insulating layer on a side, far away from the substrate, of the first metal wiring layer;
forming a pattern of a second touch detection electrode on a side, far away from the substrate, of the first insulating layer; and
forming a pattern of a second metal wiring layer which is at least electrically connected with the second touch detection electrode, in the frame area of the substrate.

2. The method according to claim 1, wherein the method further comprises:
providing a same mask to form the pattern of the first metal wiring layer and the pattern of the second metal wiring layer.

3. The method according to claim 2, wherein the providing the same mask to form the pattern of the first metal wiring layer and the pattern of the second metal wiring layer comprises:
providing the same mask to form a first metal wire connected with the first touch detection electrode, and to form a second metal wire connected with the second touch detection electrode.

4. The method according to claim 3, wherein after forming the pattern of the second metal wiring layer, the method further comprises:
forming a second insulating layer on a side, far away from the substrate, of the second metal wiring layer by an evaporation process.

5. The method according to claim 1, wherein before forming the pattern of the first touch detection electrode on the substrate, the method further comprises:
forming a pattern of a black matrix in the frame area of the substrate.

6. The method according to claim 3, wherein the first metal wiring layer comprises the first metal wire and a first connecting wire arranged in the same layer as the first metal wire, and the first connecting wire and the second metal wire are of the same shape.

7. The method according to claim 3, wherein the second metal wiring layer comprises the second metal wire and a second connecting wire arranged in the same layer as the second metal wire, and the second connecting wire and the first metal wire are of the same shape.

8. The method according to claim 1, wherein the first touch detection electrode is a touch driving electrode and the second touch detection electrode is a touch sensing electrode.

9. A touch screen, comprising:
a substrate;
a first touch detection electrode arranged on the substrate;
a first metal wiring layer arranged on a side, far away from the substrate, of a film layer in which the first touch detection electrode is located, wherein the first metal wiring layer is located in a frame area of the substrate, and the first metal wiring layer is at least electrically connected with the first touch detection electrode;
a first insulating layer arranged on a side, far away from the substrate, of the first metal wiring layer;
a second touch detection electrode arranged on a side, far away from the substrate, of the first insulating layer; and
a second metal wiring layer arranged on a side, far away from the substrate, of a film layer in which the second touch detection electrode is located, wherein the second metal wiring layer is located in the frame area of the substrate, and the second metal wiring layer is at least electrically connected with the second touch detection electrode.

10. The touch screen according to claim 9, wherein a pattern of the first metal wiring layer and a pattern of the second metal wiring layer are the same.

11. The touch screen according to claim 10, wherein the first metal wiring layer comprises a first metal wire connected with the first touch detection electrode, and the second metal wiring layer comprises a second metal wire connected with the second touch detection electrode.

12. The touch screen according to claim 11, wherein the first metal wiring layer comprises the first metal wire and a first connecting wire arranged in the same layer as the first metal wire, and the first connecting wire and the second metal wire are of the same shape.

13. The touch screen according to claim 11, wherein the second metal wiring layer comprises the second metal wire and a second connecting wire arranged in the same layer as the second metal wire, and the second connecting wire and the first metal wire are of the same shape.

14. The touch screen according to claim 9, wherein the first touch detection electrode is a touch driving electrode and the second touch detection electrode is a touch sensing electrode.

15. The touch screen according to claim 9, further comprising:
a black matrix arranged between the substrate and the first touch detection electrode, wherein the black matrix is located in the frame area.

16. The touch screen according to claim 9, further comprising:
a second insulating layer arranged on a side, far away from the substrate, of the second metal wiring layer.

17. An out-cell touch display device, comprising:
an array substrate;
an opposite substrate arranged opposite to the array substrate; and
a touch screen arranged on a side, far away from the array substrate, of the opposite substrate,
wherein the touch screen comprises a touch screen, the touch screen comprising:
a substrate;
a first touch detection electrode arranged on the substrate;
a first metal wiring layer arranged on a side, far away from the substrate, of a film layer in which the first touch detection electrode is located, wherein the first metal wiring layer is located in a frame area of the substrate, and the first metal wiring layer is at least electrically connected with the first touch detection electrode;
a first insulating layer arranged on a side, far away from the substrate, of the first metal wiring layer;
a second touch detection electrode arranged on a side, far away from the substrate, of the first insulating layer; and
a second metal wiring layer arranged on a side, far away from the substrate, of a film layer in which the second touch detection electrode is located, wherein the second metal wiring layer is located in the frame area of the substrate, and the second metal wiring layer is at least electrically connected with the second touch detection electrode.

18. The method according to claim 1, wherein the first touch detection electrode is a touch sensing electrode and the second touch detection electrode is a touch driving electrode.

19. The touch screen according to claim 9, wherein the first touch detection electrode is a touch sensing electrode and the second touch detection electrode is a touch driving electrode.
